(19) United States
(12) Patent Application Publication
(10) Pub. No.: US 2025/0187147 A1
(43) Pub. Date: Jun. 12, 2025

(54) UNIVERSAL FASTENER TIGHTENING TOOL STRUCTURALLY CONFIGURED TO ENGAGE DIFFERENT FASTENER TYPES AND/OR MITIGATE AGAINST ACCESS

(71) Applicant: PPC BROADBAND, INC., East Syracuse, NY (US)

(72) Inventor: Christopher G. BROOKER, Liverpool, NY (US)

(73) Assignee: PPC BROADBAND, INC., East Syracuse, NY (US)

(21) Appl. No.: 18/977,522

(22) Filed: Dec. 11, 2024

Related U.S. Application Data
(60) Provisional application No. 63/608,353, filed on Dec. 11, 2023.

(51) Int. Cl. B25B 7/04

(52) U.S. Cl. CPC B25B 7/04

(57) ABSTRACT

A fastener tightening tool may include a first handle portion configured to pivot relative to the first handle portion. The first handle portion may have a first grasping portion and a first fastener engaging portion and the second handle portion may have a second grasping portion and a second fastener engaging portion. The tool may include an adjusting portion structurally configured to adjust the spacing between the first fastener engaging portion and the second fastener engaging portion when the tool is in a closed position and a closure limiting portion structurally configured to limit the minimum spacing between the first fastener engaging portion and the second engaging portion when the tool is in a closed position. The first fastener engaging portion and the second fastener engaging portion may be laterally offset to mitigate against access interference.

### RELATED APPLICATION

This application claims the benefit of U.S. Provisional Application No. 63/608,353, filed Dec. 11, 2023, the entire disclosure of which is herein incorporated by reference.

### TECHNICAL FIELD

The present invention relates generally to fastener tightening tools. More particularly, the present invention relates to universal fastener tightening tools structurally configured to engage different fastener types and/or mitigate against access interference.

### BACKGROUND

Adjustable tools for tightening and loosening fasteners (e.g. nuts), such as wrenches, pliers, ratchet/socket sets, etc. are well known in the art. These prior art tools, however, may not be ideal for all applications. For example, cord grip, or cable gland, sealing nuts may have a cable extending outwardly from the nut. So, it may not be possible for a socket or closed end ratchet or wrench to properly surround and secure the nut since the socket or closed end ratchet or wrench cannot get over the cable to be properly positioned on the nut.

Open-ended adjustable wrenches, such as crescent wrenches, also have limitations. Generally, these wrenches are not easily tightened to the proper nut size, which can lead to stripping of the nut and/or an inability to use the required amount of torque. Further, cord grip, or cable gland, sealing nuts, with cables extending therefrom, may be closely spaced adjacent each other. As a result, the limited space may cause problems accessing the nuts, grasping the handles of the tool, and turning/rotating the tools without interference.

Because of problems of stripping the nuts and access to the nuts, in addition to the potential of needing to tighten/loosen nuts of different sizes, many technicians need to keep several different tools on hand.

Further, it is common for some sealing nuts to be made of plastic. Using a plier-style tool (e.g., channel locks) to tighten or loosen the sealing nut can damage the plastic sealing nut by crushing the nut due to overclosure or deforming the outer surface of the nut with teeth on the jaws of the tool.

Therefore, it may be desirable to provide a universal fastener tightening tool that is structurally configured to engage different fastener types. It may also be desirable to provide a fastener tightening tool that is structurally configured to mitigate access interference. It may also be desirable to provide a fastener tightening tool that prevents damage to the fastener due to overclosure. It may also be desirable to provide a tool that is configured to withstand a high amount of torque without fear of stripping the fastener.

### SUMMARY

Embodiments of the disclosure provide for universal fastener tightening tool structurally configured to engage different fastener types and/or mitigate against access interference.

In some embodiments, the nut tightening tool may include a distal end portion, a proximal end portion opposite the distal end portion, a first handle portion having a first grasping portion at the proximal end portion and a first nut engaging portion at the distal end portion, and a second handle portion having a second grasping portion at the proximal end portion and a second nut engaging portion at the distal end portion.

In some embodiments, the first handle portion may be connected to the second handle portion by a pivot connection portion structurally configured to allow the first handle portion to pivot about a pivot axis relative to the second handle portion.

In some embodiments, the tool may include an adjusting portion structurally configured to adjust a spacing between the first nut engaging portion and the second nut engaging portion when the tool is in a closed position

In some embodiments, the tool may include a closure limiting portion structurally configured to limit a minimum spacing between the first nut engaging portion and the second engaging portion when the tool is in a closed position.

In some embodiments, the first nut engaging portion may include a first flat surface portion and a second flat surface portion and the second nut engaging portion may include a third flat surface portion and a fourth flat surface portion.

In some embodiments, the first nut engaging portion and the second nut engaging portion may be laterally offset from at least one of a first side wall portion of the first handle portion or a second side wall portion of the second handle portion.

In some embodiments, the closure limiting portion may be structurally configured such that, when in the closed position, the first flat surface portion is parallel with the fourth flat surface portion and the second flat surface portion is parallel with the third flat surface portion.

In some embodiments, the pivot connection portion may include a pivot pin portion and a pivot pin receiving portion structurally configured to receive the pivot pin portion.

In some embodiments, the pivot pin portion may extend from the first handle portion and is positioned between the first grasping portion and the first nut engaging portion, and wherein the pivot pin receiving portion is positioned on the second handle portion between the second gasping portion and second nut engaging portion.

In some embodiments, the adjusting portion may include a plurality of spaced-apart receiving portions on the second handle portion and a projecting portion extending from the first handle portion and structurally configured to be received in any of the plurality of spaced-apart receiving portions.

In some embodiments, the plurality of spaced-apart receiving portions may include a channel portion closed at one end by an end wall portion.

In some embodiments, the positioning of the receiving portions may correspond to different predetermined nut sizes.

In some embodiments, the closure limiting portion may include a stop portion structurally configured to abut the projecting portion when the projecting portion is received in any of the receiving portions such that, when in the closed position, the first flat surface portion is parallel with the fourth flat surface portion and the second flat surface portion is parallel with the third flat surface portion.

In some embodiments, the stop portion may include an end wall portion associated with each of the plurality of spaced-apart receiving portions.

In some embodiments, the first flat surface portion may extend distally from the second flat surface portion to form a first V-shape and the third flat surface portion extends distally from the fourth flat surface portion to form a second V-shape.

In some embodiments, the first and second gripping portions may be structurally configured to have a length that, when the tool is tightening a first nut, permits the first and second handle portions to extend over an adjacent second nut so that the adjacent second nut does not interfere the first and second handle portions.

In some embodiments, the tool may include a distal end portion, a proximal end portion opposite the distal end portion, a first handle portion having a first grasping portion at the proximal end portion and a first nut engaging portion at the distal end portion, and a second handle portion having a second grasping portion at the proximal end portion and a second nut engaging portion at the distal end portion.

In some embodiments, the first handle portion may be connected to the second handle portion by a pivot connection portion structurally configured to allow the first handle portion to pivot about a pivot axis relative to the second handle portion.

In some embodiments, the tool may include an adjusting portion structurally configured to adjust a spacing between the first nut engaging portion and the second nut engaging portion when the tool is in a closed position.

In some embodiments, the tool may include a closure limiting portion structurally configured to limit a minimum spacing between the first nut engaging portion and the second engaging portion when the tool is in a closed position.

In some embodiments, the pivot connection portion may include a pivot pin portion and a pivot pin receiving portion structurally configured to receive the pivot pin portion. In some embodiments, the pivot pin portion may extend from the first handle portion and may be positioned between the first grasping portion and the first nut engaging portion. In some embodiments, the pivot pin receiving portion may be positioned on the second handle portion between the second gasping portion and second nut engaging portion.

In some embodiments, the first nut engaging portion may include a first flat surface portion and a second flat surface portion and the second nut engaging portion includes a third flat surface portion and a fourth flat surface portion.

In some embodiments, the first flat surface portion, the second flat surface portion, the third flat surface portion, and the fourth flat surface portion may be structurally configured to engage the nut at a position that is laterally offset from at least one of a first side wall portion of the first handle portion or a second side wall portion of the second handle portion.

In some embodiments, the adjusting portion may include a plurality of spaced-apart receiving portions on the second handle portion and a projecting portion extending from the first handle portion and structurally configured to be received in any of the plurality of spaced-apart receiving portions.

In some embodiments, positioning of the receiving portions may correspond to different predetermined nut sizes.

In some embodiments, the second handle portion may be structurally configured to be pivoted to disengage the projecting portion from a first of the plurality of receiving portions and slid relative to the first handle portion such that the pivot pin portion slides within the pivot pin receiving portion to position the projecting portion to be received in a second of the plurality of receiving portions.

In some embodiments, the closure limiting portion may include a stop portion structurally configured to abut the projecting portion when the projecting portion is received in any of the receiving portions such that, when in the closed position, the first flat surface portion is parallel with the fourth flat surface portion and the second flat surface portion is parallel with the third flat surface portion.

In some embodiments, the first handle portion and the second handle portion may be structurally configured to adjust to engage different nut types and/or mitigate against access interference and/or prevent damage to the nut due to overclosure.

In some embodiments, the first flat surface portion may extends distally from the second flat surface portion to form a first V-shape and the third flat surface portion extends distally from the fourth flat surface portion to form a second V-shape.

In some embodiments, the first flat surface portion may extend at an angle of 120 degrees relative to the second flat surface portion.

In some embodiments, the first flat surface portion, the second flat surface portion, the third flat surface portion, and the fourth flat surface portion may be laterally offset at least two inches.

In some embodiments, the first and second gripping portions may be structurally configured to have a length that, when the tool is tightening a first nut, permits the first and second handle portions to extend over an adjacent second nut so that the adjacent second nut does not interfere the first and second handle portions.

In some embodiments, a universal fastener tightening tool structurally configured to engage different fastener types and/or mitigate against access interference may include a distal end portion, a proximal end portion opposite the distal end portion, a first handle portion having a first grasping portion at the proximal end portion and a first nut engaging portion at the distal end portion and a second handle portion having a second grasping portion at the proximal end portion and a second nut engaging portion at the distal end portion.

In some embodiments, the first handle portion may be connected to the second handle portion by a pivot connection portion structurally configured to allow the first handle portion to pivot about a pivot axis relative to the second handle portion.

In some embodiments, the tool may include an adjusting portion structurally configured to adjust a spacing between the first fastener engaging portion and the second fastener engaging portion when the tool is in a closed position.

In some embodiments, the tool may include a closure limiting portion structurally configured to limit a minimum spacing between the first fastener engaging portion and the second fastener engaging portion when the tool is in a closed position.

In some embodiments, the first fastener engaging portion may include a first flat surface portion and a second flat surface portion and the second fastener engaging portion may include a third flat surface portion and a fourth flat surface portion.

In some embodiments, the first fastener engaging portion and the second fastener engaging portion are laterally offset from at least one of a first side wall portion of the first handle portion or a second side wall portion of the second handle portion.

In some embodiments, the adjusting portion may include a plurality of spaced-apart receiving portions and a projecting portion structurally configured to be received in any of the plurality of spaced-apart receiving portions.

In some embodiments, the closure limiting portion may include a stop portion structurally configured to abut the projecting portion when the projecting portion is received in any of the receiving portions such that, when in the closed position, the first flat surface portion is parallel with the fourth flat surface portion and the second flat surface portion is parallel with the third flat surface portion.

In some embodiments, each of the plurality of spaced-apart receiving portions may include a channel portion closed at one end by the stop portion.

In some embodiments, the first handle portion and the second handle portion may be structurally configured to adjust to engage different fastener types and/or mitigate against access interference and/or prevent damage to the fastener due to overclosure.

In some embodiments, the pivot connection portion may include a pivot pin portion and a pivot pin receiving portion structurally configured to receive the pivot pin portion.

In some embodiments, the pivot pin portion may extend from the first handle portion and be positioned between the first grasping portion and the first fastener engaging portion. In some embodiments, the pivot pin receiving portion may be positioned on the second handle portion between the second gasping portion and second fastener engaging portion.

In some embodiments, the positioning of the receiving portions may correspond to different predetermined fastener sizes.

In some embodiments, the second handle portion may be structurally configured to be pivoted to disengage the projecting portion from a first of the plurality of receiving portions and slid relative to the first handle portion such that the pivot pin portion slides within the pivot pin receiving portion to position the projecting portion to be received in a second of the plurality of receiving portions.

In some embodiments, the first flat surface portion may extend distally from the second flat surface portion to form a first V-shape and the third flat surface portion extends distally from the fourth flat surface portion to form a second V-shape.

Various aspects of the universal nut tightening tool, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a perspective view of an exemplary tool for tightening sealing nuts in accordance with various aspects of the disclosure.

FIG. 2 is a partially cut-away side plan view of the tool of FIG. 1 in a first adjusted position.

FIG. 3 is a partially cut-away side plan view of the tool of FIG. 1 in a second adjusted position.

FIG. 4 is a perspective view of adjustable jaws of the tool of FIG. 1 in accordance with various aspects of the disclosure.

FIG. 5 is a perspective view of the tool engaging one of various sized sealing nuts.

### DETAILED DESCRIPTION OF EMBODIMENTS

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims. As will be understood, like parts will be referred to with like reference numerals.

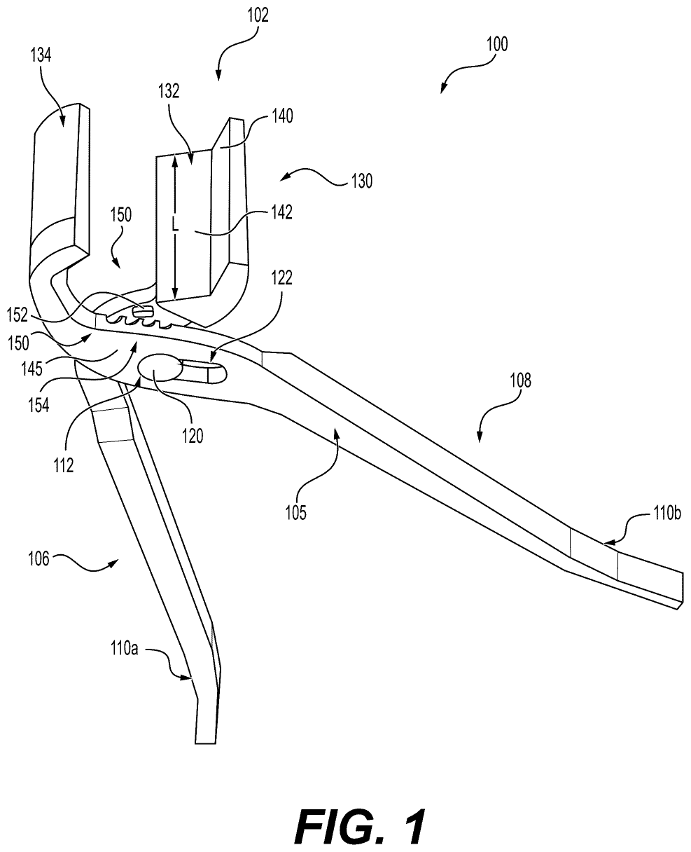

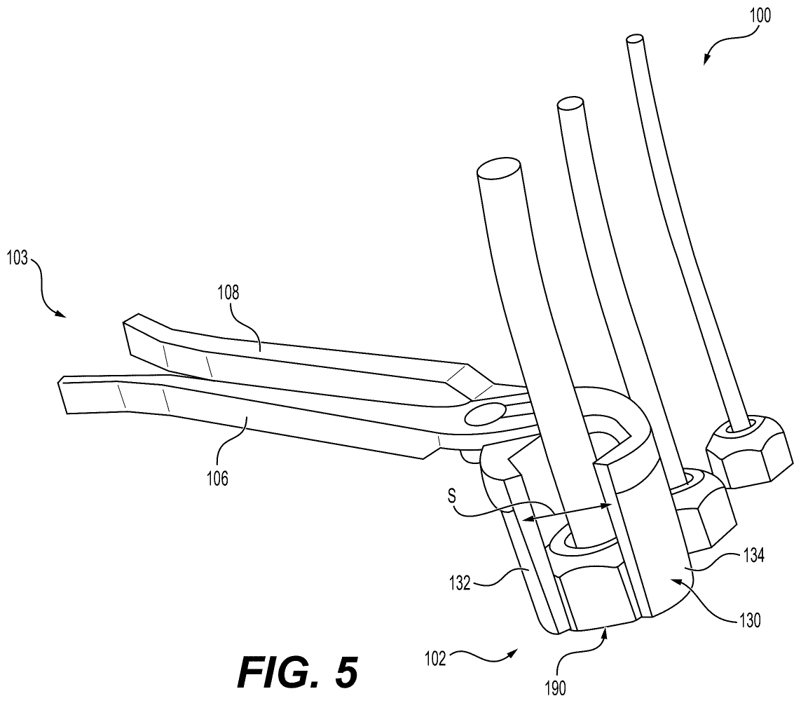

FIGS. 1-3 depict a universal, adjustable tool 100 structurally configured to tighten and loosen fasteners 190 (e.g., nuts, such as sealing nuts). Fasteners 190, as shown in FIG. 5, may include sealing nuts having a cable extending therefrom. It should be appreciated that in some cases, a bolt rather than a cable may extend outwardly from a fastener, such as a nut. Therefore, wherever the specification mentions a cable extending outwardly from the fastener, the description applies equally to a bolt extending outwardly from the fastener.

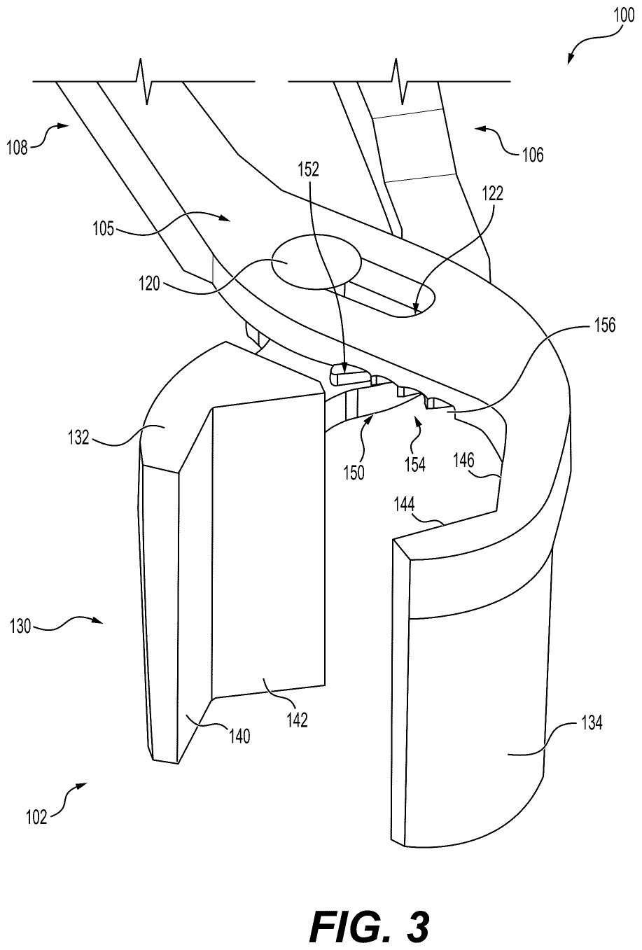

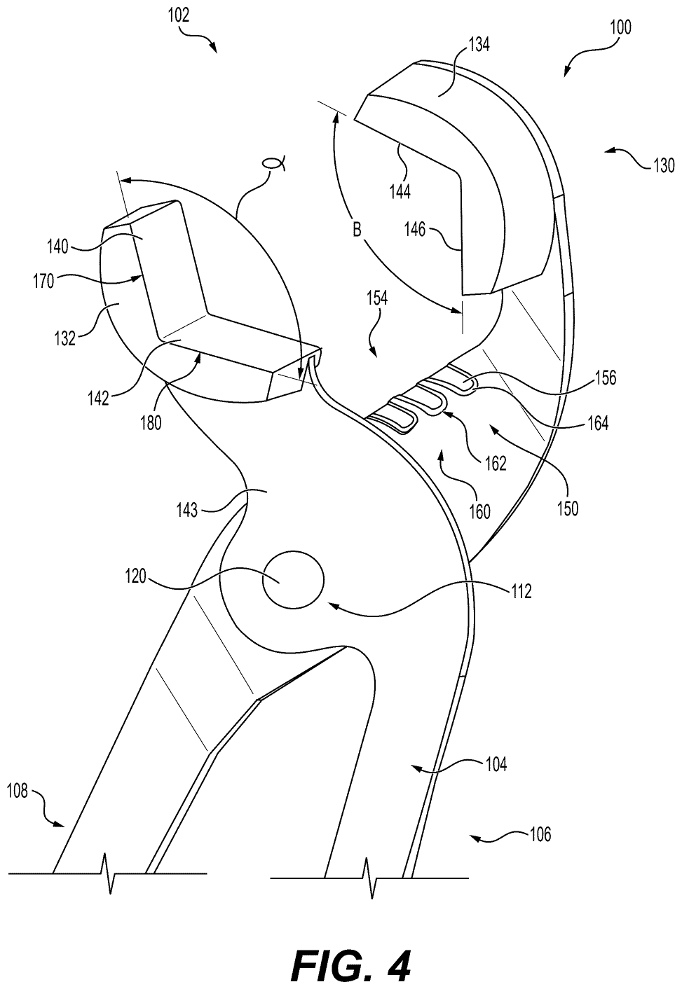

The tool 100 (e.g., pliers) may be configured in a variety of ways. In some embodiments, the tool 100 may have a distal end portion 102, a proximal end portion 103 opposite the distal end portion 102, a first side or lateral portion 104 (FIG. 4) extending between the distal end portion 102 and the proximal end portion 103, and a second side or lateral portion 105 (FIG. 3) opposite the first side or lateral portion 104 and extending between the distal end portion 102 and the proximal end portion 103. In some embodiments, the tool 100 may include a first handle portion 106 having a first grasping portion 110a and a second handle portion 108 having a second grasping portion 110b. The first grasping portion 110a and the second grasping portion 110b may be structurally configured to provide an area for the tool 100 to be grasped and/or gripped by a user. In some embodiments, the first grasping portion 110a and the second grasping portion 110b may be positioned at the proximal end portion 103.

In some embodiments, the first handle portion 106 and the second handle portion 108 may be securely and pivotally connected by way of a pivot connection portion 112 such that the first handle portion 106 may pivot relative to the second handle portion 108 about a pivot axis. In some embodiments, for example, the pivot connection portion 112 may include a pivot pin portion 120 (e.g., a pin, projection, etc.) and a pivot pin receiving portion 122 (e.g., aperture, slot, channel, opening, etc.). In some embodiments, the pivot pin portion 120 may extend from a side portion of the first handle portion 106 and be received in the pivot pin receiving portion 122 on the second handle portion 108.

In some embodiments, the tool 100 may include a fastener or nut gripping portion 130 (e.g., an adjustable jaw). In some embodiments, the nut gripping portion 130 may be positioned at the distal end portion 102 of the tool 100. In some embodiments, the nut gripping portion 130 may include a first fastener or nut engaging portion 132 and a second fastener or nut engaging portion 134. In some embodiments, the first nut engaging portion 132 may be positioned at the distal end portion 102 on the first handle portion 106 opposite the first grasping portion 110a and the second nut engaging portion 134 may be positioned at the distal end portion 102 on the second handle portion 108 opposite the second grasping portion 110b.

Referring to FIG. 4, the first nut engaging portion 132 and the second nut engaging portion 134 may be structurally configured to engage a fastener or nut 190 (FIG. 5). In some embodiments, the first nut engaging portion 132 and the second nut engaging portion 134 may include surface portions (e.g. flat, planar, serrated, dimpled, toothed, etc.) that may be structurally configured to engage the flats of a nut. For example, in some embodiments, the first nut engaging portion 132 may include a first flat surface portion 140 and a second flat surface portion 142.

In some embodiments, the first flat surface portion 140 may be contiguous with the second flat surface portion 142. In some embodiments, the first flat surface portion 140 extends distally from the second flat surface portion 142. In some embodiments, the first flat surface portion 140 and a second flat surface portion 142 may be structurally configured in a “V” shape such that the first flat surface portion 140 and the second flat surface portion 142 form an angle α therebetween. In some embodiments, the angle α may be 120° so as to accommodate normal sized hexagonally shaped nuts.

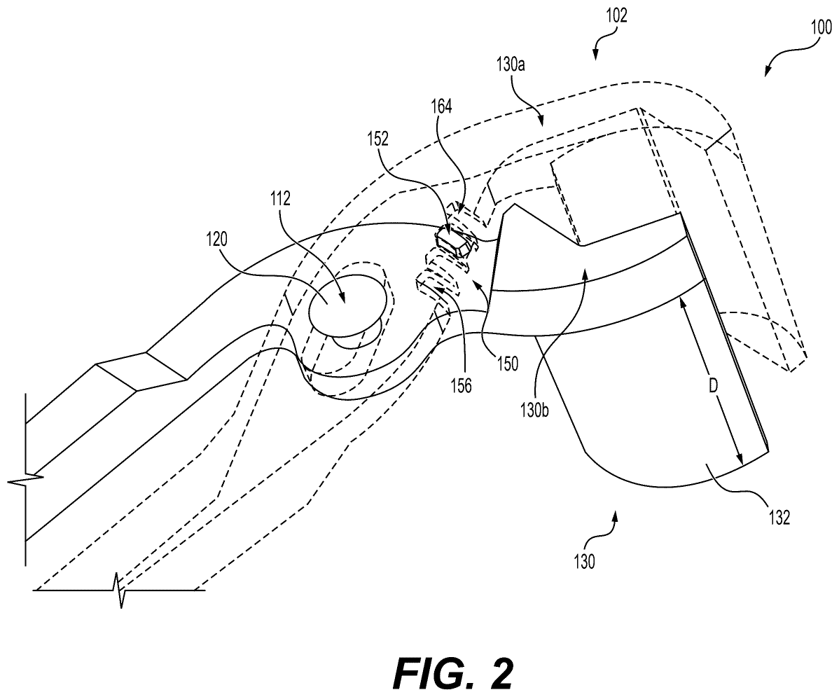

In some embodiments, the first flat surface portion 140 and the second flat surface portion 142 of the first nut engaging portion 132 may extend laterally outward from at least one of the first side or lateral portion 104 or the second side or lateral portion 105 or may be laterally offset from at least one of the first side or lateral portion 104 or the second side or lateral portion 105. For example, in some embodiments, at least a portion of the first flat surface portion 140 and the second flat surface portion 142 that are structurally configured to engage the sealing nut 190 may be laterally offset from the first side or lateral portion 104 a distance D (FIG. 2), wherein the first side or lateral portion 104 is at least partially defined by a first sidewall portion 143 (FIG. 4) of the first handle portion 106 positioned proximately relative to the first nut engaging portion 132. In some embodiments (not shown), at least a portion of the first flat surface portion 140 and the second flat surface portion 142 that are structurally configured to engage the sealing nut 190 may be laterally offset from the second side or lateral portion 105 the distance D, wherein the second side or lateral portion 105 is at least partially defined by a second sidewall portion 145 (FIG. 1) of the second handle portion 108 positioned proximately relative to the first nut engaging portion 132. In some embodiments (not shown), the entire first flat surface portion 140 and the second flat surface portion 142 may be laterally offset from the first side or lateral portion 104 and/or the second side or lateral portion 105.

In some embodiments, the first flat surface portion 140 and the second flat surface portion 142 may extend from the first side or lateral portion 104 past the second side or lateral portion 105 and laterally outward the distance D. In some embodiments, the first nut engaging portion 132 (e.g., the first and second flat surface portions 140, 142) may have a length L (FIG. 1). In some embodiments, the length L may be in the range of 2 inches to 3 inches. In other embodiments, the length L may be greater than 3 inches (e.g., greater than 3.5 inches, greater than 4 inches, etc.) or less than 2 inches.

In some embodiments, the second nut engaging portion 134 may include a first flat surface portion 144 and a second flat surface portion 146. In some embodiments, the first flat surface portion 144 may be contiguous with the second flat surface portion 146. In some embodiments, the first flat surface portion 144 extends distally from the second flat surface portion 146. In some embodiments, the first flat surface portion 144 and a second flat surface portion 146 may be structurally configured in a “V” shape such that the first flat surface portion 144 and the second flat surface portion 146 form an angle β therebetween. In some embodiments, the angle β may be 120° so as to accommodate normal sized hexagonally shaped nuts. In some embodiments the angle α and the angle β are configured to be the same.

In some embodiments, the first flat surface portion 144 and the second flat surface portion 146 of the second nut engaging portion 134 may extend laterally outward from at least one of the first side or lateral portion 104 or the second side or lateral portion 105 or may be laterally offset from at least one of the first side or lateral portion 104 or the second side or lateral portion 105. For example, in some embodiments, at least a portion of the first flat surface portion 144 and the second flat surface portion 146 may be laterally offset from the second side or lateral portion 105 a distance D, wherein the first side or lateral portion 104 is at least partially defined by the first sidewall portion 143 of the first handle portion 106 positioned proximately relative to the second nut engaging portion 134. In some embodiments, at least a portion of the first flat surface portion 144 and the second flat surface portion 146 that are structurally configured to engage the sealing nut 190 may be laterally offset from the second side or lateral portion 105 a distance D, wherein the second side or lateral portion 105 is at least partially defined by the second sidewall portion 145 of the second handle portion 108 positioned proximately relative to the second nut engaging portion 134.

For example, in some embodiments, the first flat surface portion 144 and the second flat surface portion 146 may extend from the first side or lateral portion 104 past the second side or lateral portion 105 and laterally outward the distance D. In some embodiments, the second nut engaging portion 134 (e.g., the first and second flat surface portions 144, 146) may have a length L. In some embodiments, the length L may be in the range of 2 inches to 3 inches. In other embodiments, the length L may be greater than 3 inches (e.g., greater than 3.5 inches, greater than 4 inches, etc.) or less than 2 inches.

In some embodiments, the tool 100 may include an adjusting portion 150 structurally configured to allow the tool 100 to adjust the nut gripping portion 130 to grip nuts 190 of different sizes. For example, the adjusting portion 150 may be structurally configured to adjust the spacing S (FIG. 5) between the first and second nut engaging portions 132, 134 when the tool 100 is in a closed position. The adjusting portion 150 may be configured in a variety of ways. In some embodiments, the adjusting portion 150 may include a projecting portion 152 (e.g., a protrusion, projection, ridge, raised area, etc.) structurally configured to engage a receiving portion 154 (e.g., a locking area or window slot or channel portion). In some embodiments, the projecting portion 152 may be affixed to the first handle portion 106 and disposed proximally relative to the nut gripping portion 130.

In some embodiments, the receiving portion 154 may include a plurality of spaced apart receiving portions 156 formed as radial notches, slots, channels, indentions, or the like. In some embodiments, the receiving portion 154 may be positioned on the second handle portion 108 and disposed proximally relative to the nut gripping portion 130. The spacing between adjacent receiving portions 156 may be structurally configured to correspond to different predetermined nut sizes.

The projecting portion 152 may be structurally configured to be moved relative to the receiving portion 154 to be received within one of the plurality of spaced apart receiving portions 156 as desired. For example, to adjust the nut gripping portion 130 to grip a different sized nut, the projecting portion 152 may be removed from a first of the plurality of spaced apart receiving portions 156 by pivoting the first and second handle portions 106, 108 apart (i.e., opening the tool or spreading the handle portions apart). The second handle portion 108 may then be slid relative to the first handle portion 106 such that the pivot pin portion 120 moves along the pivot pin receiving portion 122 until the projecting portion 152 is positioned to be received within a second of the plurality of spaced apart receiving portions 156. The projecting portion 152 may be received into the second of the plurality of spaced apart receiving portions 156 by pivoting the first and second handle portions 106, 108 together (i.e., closing the tool or moving the handle portions toward each other).

The tool 100 may include a closure limiting portion 160 structurally configured to limit the minimum spacing between the first and second nut engaging portion 132, 134 when the tool 100 is in the closed position. The closure limiting portion 160 may be structurally configured to prevent overclosure of the nut gripping portion 130. Since it is common for some sealing nuts to be made of plastic, the closure limiting portion 160 may be structurally configured to avoid damaging (i.e., crushing) the sealing nut 190 during tightening.

The closure limiting portion 160 may be configured in a variety of ways. In some embodiments, the closure limiting portion 160 may include a stop portion 162 structurally configured to block the nut gripping portion 130 from closing beyond a certain point. In some embodiments, the stop portion 162 may include a shoulder portion or end wall portion 164 associated with each of the plurality of spaced apart receiving portions 156. For example, each of the plurality of spaced apart receiving portions 156 may be closed by the end wall portion 164 on one end of the receiving portion 156. Thus, when the projecting portion 152 is received within one of the receiving portions 156, the projecting portion 152 may abut the stop portion 162 to block further closure of the tool 100.

In some embodiments, the stop portion 162 is structurally configured to stop further closure of the tool when the first flat surface portion 140 of the first nut engaging portion 132 is parallel with the second flat surface portion 146 of the second nut engaging portion 134 and the second flat surface portion 142 of the first nut engaging portion 132 is parallel with the first flat surface portion 144 of the second nut engaging portion 134. Thus, in some embodiments, when one of the plurality of spaced apart receiving portions 156 receives the projecting portion 152, the pressure exerted on the projecting portion 152 from closing the tool 100 will secure the projecting portion 152 against the stop portion 162 within receiving portion 156 while preventing overclosure of the nut gripping portion 130.

As shown in FIG. 5, the tool 100 may be used to tighten and loosen various sized sealing nuts 190. Further, the open-ended configuration of the nut gripping portion 130 allows the tool 100 to be readily received onto a sealing nut 190 with a cable or bolt extending from the sealing nut 190. Further, since the portion of the flat surface portions 140, 142, 144, 146 that directly engage the sealing nut 190 are laterally offset from the second side or lateral portion 105 of the tool 100 (i.e., the handle portions 106, 108), the handle portions 106, 108 may be positioned the distance D away from the sealing nut 190 (as shown in FIG. 5). As a result, the tool 100 may be rotated about the sealing nut 190 without the handle portions 106, 108 being interfered with by adjacent sealing nuts while adjacent cables may be bent out of the way.

The tool 100 of the present invention may provide a simple, yet durable, adjustable tool 100 that can replace a wide number of other wrenches. The tool may be designed for English, metric, or other units, and can have as many different sizes as desired. The tool 100 may be used on hexagonal nuts or objects but may also be used on square nuts or other polygonal-shaped objects. Furthermore, because the tool is open-ended, it is more convenient to use in tight areas where a socket wrench or closed-ended wrench might not be practical. The adjusting portion 150 and closure limiting portion 160 allows a nut to be held securely for torquing while avoiding potentially damaging the nut due to overclosure, while still allowing simple adjustment from one size to another in an exact and precise manner (unlike adjustable wrenches which have a tendency to loosen during use or not be exactly fit to a nut, both of which can lead to damaging the nut, e.g., rounding the corners of the nut).

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A universal nut tightening tool structurally configured to engage different nut types and/or mitigate against access interference, comprising:
a distal end portion;
a proximal end portion opposite the distal end portion;
a first handle portion having a first grasping portion at the proximal end portion and a first nut engaging portion at the distal end portion;
a second handle portion having a second grasping portion at the proximal end portion and a second nut engaging portion at the distal end portion, wherein the first handle portion is connected to the second handle portion by a pivot connection portion structurally configured to allow the first handle portion to pivot about a pivot axis relative to the second handle portion;
an adjusting portion structurally configured to adjust a spacing between the first nut engaging portion and the second nut engaging portion when the tool is in a closed position;
a closure limiting portion structurally configured to limit a minimum spacing between the first nut engaging portion and the second engaging portion when the tool is in a closed position;
wherein the pivot connection portion includes a pivot pin portion and a pivot pin receiving portion structurally configured to receive the pivot pin portion, wherein the pivot pin portion extends from the first handle portion and is positioned between the first grasping portion and the first nut engaging portion, and wherein the pivot pin receiving portion is positioned on the second handle portion between the second gasping portion and second nut engaging portion;
wherein the first nut engaging portion includes a first flat surface portion and a second flat surface portion, and the second nut engaging portion includes a third flat surface portion and a fourth flat surface portion;
wherein the first flat surface portion, the second flat surface portion, the third flat surface portion, and the fourth flat surface portion are structurally configured to engage a nut at a position that is laterally offset from at least one of a first side wall portion of the first handle portion or a second side wall portion of the second handle portion;
wherein the adjusting portion includes a plurality of spaced-apart receiving portions on the second handle portion and a projecting portion extending from the first handle portion and structurally configured to be received in any of the plurality of spaced-apart receiving portions;
wherein the positioning of the receiving portions corresponds to different predetermined nut sizes;
wherein the second handle portion is structurally configured to be pivoted to disengage the projecting portion from a first of the plurality of receiving portions and slid relative to the first handle portion such that the pivot pin portion slides within the pivot pin receiving portion to position the projecting portion to be received in a second of the plurality of receiving portions;
wherein the closure limiting portion include a stop portion structurally configured to abut the projecting portion when the projecting portion is received in any of the receiving portions such that, when in the closed position, the first flat surface portion is parallel with the fourth flat surface portion and the second flat surface portion is parallel with the third flat surface portion; and
wherein the first handle portion and the second handle portion are structurally configured to adjust to engage different nut types and/or mitigate against access interference.

2. The universal nut tightening tool according to claim 1, wherein the first flat surface portion extends distally from the second flat surface portion to form a first V-shape, and the third flat surface portion extends distally from the fourth flat surface portion to form a second V-shape.

3. The universal nut tightening tool according to claim 1, wherein the first flat surface portion extends at an angle of 120 degrees relative to the second flat surface portion.

4. The universal nut tightening tool according to claim 1, wherein the first flat surface portion, the second flat surface portion, the third flat surface portion, and the fourth flat surface portion are laterally offset at least two inches.

5. The universal nut tightening tool according to claim 1, wherein the first and second gripping portions are structurally configured to have a length that, when the tool is tightening a first nut, permits the first and second handle portions to extend over an adjacent second nut so as to prevent the adjacent second nut from interfering with the first and second handle portions.

6. A universal nut tightening tool structurally configured to engage different nut types and/or mitigate against access interference, comprising:
a distal end portion;
a proximal end portion opposite the distal end portion;
a first handle portion having a first grasping portion at the proximal end portion and a first nut engaging portion at the distal end portion;
a second handle portion having a second grasping portion at the proximal end portion and a second nut engaging portion at the distal end portion, wherein the first handle portion is connected to the second handle portion by a pivot connection portion structurally configured to allow the first handle portion to pivot about a pivot axis relative to the second handle portion;
an adjusting portion structurally configured to adjust a spacing between the first nut engaging portion and the second nut engaging portion when the tool is in a closed position;
a closure limiting portion structurally configured to limit a minimum spacing between the first nut engaging portion and the second engaging portion when the tool is in a closed position;
wherein the first nut engaging portion includes a first flat surface portion and a second flat surface portion and the second nut engaging portion includes a third flat surface portion and a fourth flat surface portion;
wherein first nut engaging portion and the second nut engaging portion are laterally offset from at least one of a first side wall portion of the first handle portion or a second side wall portion of the second handle portion;
wherein the adjusting portion includes a plurality of spaced-apart receiving portions and a projecting portion structurally configured to be received in any of the plurality of spaced-apart receiving portions;
wherein the closure limiting portion includes a stop portion structurally configured to abut the projecting portion when the projecting portion is received in any of the receiving portions such that, when in the closed position, the first flat surface portion is parallel with the fourth flat surface portion and the second flat surface portion is parallel with the third flat surface portion;
wherein the each of the plurality of spaced-apart receiving portions includes a channel portion closed at one end by the stop portion; and
wherein the first handle portion and the second handle portion are structurally configured to adjust to engage different nut types and/or mitigate against access interference.

7. The universal nut tightening tool according to claim 6, wherein the pivot connection portion includes a pivot pin portion and a pivot pin receiving portion structurally configured to receive the pivot pin portion, wherein the pivot pin portion extends from the first handle portion and is positioned between the first grasping portion and the first nut engaging portion, and wherein the pivot pin receiving portion is positioned on the second handle portion between the second gasping portion and second nut engaging portion.

8. The universal nut tightening tool according to claim 6, wherein positioning of the receiving portions corresponds to different predetermined nut sizes.

9. The universal nut tightening tool according to claim 7, wherein the second handle portion is structurally configured to be pivoted to disengage the projecting portion from a first of the plurality of receiving portions and slid relative to the first handle portion such that the pivot pin portion slides within the pivot pin receiving portion to position the projecting portion to be received in a second of the plurality of receiving portions.

10. The universal nut tightening tool according to claim 6, wherein the first flat surface portion extends distally from the second flat surface portion to form a first V-shape and the third flat surface portion extends distally from the fourth flat surface portion to form a second V-shape.

11. The universal nut tightening tool according to claim 6, wherein the first and second gripping portions are structurally configured to have a length that, when the tool is tightening a first nut, permits the first and second handle portions to extend over an adjacent second nut so as to prevent the adjacent second nut from interfering with the first and second handle portions.

12. A universal fastener tightening tool structurally configured to engage different fastener types and/or mitigate against access interference, comprising:
a distal end portion;
a proximal end portion opposite the distal end portion;
a first handle portion having a first grasping portion at the proximal end portion and a first fastener engaging portion at the distal end portion;
a second handle portion having a second grasping portion at the proximal end portion and a second fastener engaging portion at the distal end portion, wherein the first handle portion is connected to the second handle portion by a pivot connection portion structurally configured to allow the first handle portion to pivot about a pivot axis relative to the second handle portion;
an adjusting portion structurally configured to adjust a spacing between the first fastener engaging portion and the second fastener engaging portion when the tool is in a closed position;
a closure limiting portion structurally configured to limit a minimum spacing between the first fastener engaging portion and the second engaging portion when the tool is in a closed position;
wherein first fastener engaging portion and the second fastener engaging portion are structurally configured to be laterally offset from at least one of a first side wall portion of the first handle portion or a second side wall portion of the second handle portion; and
wherein the first handle portion and the second handle portion are structurally configured to adjust to engage different fastener types and/or mitigate against access interference.

13. The universal fastener tightening tool according to claim 12, wherein the pivot connection portion includes a pivot pin portion and a pivot pin receiving portion structurally configured to receive the pivot pin portion.

14. The universal fastener tightening tool according to claim 13, wherein the pivot pin portion extends from the first handle portion and is positioned between the first grasping portion and the first fastener engaging portion, and wherein the pivot pin receiving portion is positioned on the second handle portion between the second gasping portion and second fastener engaging portion.

15. The universal fastener tightening tool according to claim 12, wherein the adjusting portion includes a plurality of spaced-apart receiving portions on the second handle portion and a projecting portion extending from the first handle portion and structurally configured to be received in any of the plurality of spaced-apart receiving portions.

16. The universal fastener tightening tool according to claim 15, wherein each of the plurality of spaced-apart receiving portions includes a channel portion closed at one end by an end wall portion.

17. The universal fastener tightening tool according to claim 15, wherein positioning of the receiving portions corresponds to different predetermined fastener sizes.

18. The universal fastener tightening tool according to claim 15, wherein the closure limiting portion includes a stop portion structurally configured to abut the projecting portion when the projecting portion is received in any of the receiving portions such that, when in the closed position, the first flat surface portion is parallel with the fourth flat surface portion and the second flat surface portion is parallel with the third flat surface portion.

19. The universal fastener tightening tool according to claim 18, wherein the stop portion includes end wall portion associated with each of the plurality of spaced-apart receiving portions.

20. The universal fastener tightening tool according to claim 12, wherein the first flat surface portion extends distally from the second flat surface portion to form a first V-shape and the third flat surface portion extends distally from the fourth flat surface portion to form a second V-shape.

21. The universal fastener tightening tool according to claim 12, wherein the first and second gripping portions are structurally configured to have a length that, when the tool is tightening a first fastener, permits the first and second handle portions to extend over an adjacent second fastener so as to prevent the adjacent second fastener from interfering with the first and second handle portions.
